(19) United States
(12) Patent Application Publication
(10) Pub. No.: US 2015/0032440 A1
(43) Pub. Date: Jan. 29, 2015

(54) Method for Providing Translations to an E-Reader and System Thereof

(71) Applicant: Ortsbo Inc., New York, NY (US)

(72) Inventor: Mark Charles Hale, Whitby (CA)

(21) Appl. No.: 14/382,901

(22) PCT Filed: Mar. 4, 2013
(86) PCT No.: PCT/US13/28802

§ 371 Date: Sep. 4, 2014

Related U.S. Application Data
(60) Provisional application No. 61/607,894, filed on Mar. 7, 2012.

(51) Int. Cl. G06F 17/28

(52) U.S. Cl. CPC G06F 17/289
USPC 704/3

(57) ABSTRACT

An eReader displays contents of an eBook and, in response to a user request, obtains a translation of text in the eBook and displays the translated text. Optionally, the eReader uses text-to-speech technology to read the translated text to the user.

### CROSS REFERENCE TO RELATED APPLICATIONS

This application claims the benefit of U.S. Provisional Patent Application No. 61/607,894, filed Mar. 7, 2012, titled “Method for Providing Translations to an e-Reader and System Thereof,” the entire contents of which are hereby incorporated by reference herein, for all purposes.

### TECHNICAL FIELD

The present invention relates to a method of providing translations of documents for electronic reading devices. The invention further relates to a method of providing translated audio output of documents for electronic devices.

### BACKGROUND ART

A barrier in the vision of a global village is breaking down language barriers. Many steps have been taken to begin breaking down language barriers, particularly with regards to the written word. There are systems, for example, as disclosed in United States Patent Publication US 2011/0261030 A1, wherein electronic reading devices include the capability of allow the reader to highlight or selected specific word or phrases on the display and be provided a translation of the word or phrase in a second language. In U.S. publication US 2011/0261030 A1, the system includes additional context-specific information embedded in an eBook additional to the text of the book in order to facilitate improved translation of the selected word or phrase.

### SUMMARY OF EMBODIMENTS

An embodiment of the present invention provides a method for providing translated written contents for display on an electronic reading device. The method includes receiving from the electronic reading device a translation request to translate the written contents from a first language to a second language. The written contents is received from the electronic reading device in the first language for translation. The written contents are translated into the second language. The translated written contents are sent to the electronic reading device for display.

The written contents comprises may include an eBook or a chapter of an eBook.

Optionally, the translated written contents may be converted from a digital written format to an audio signal representing the translated written contents in spoken form. The audio signal may be played.

The written contents comprises may include an eBook or a chapter of an eBook.

An embodiment of the present invention provides a system for translating and displaying written contents. The system includes an electronic reading device configured to display the written contents. A user interface on said electronic reading device is configured to receive an input indicating a language of the written contents and a designated language, into which to translate the written contents. A translation module in communication with the electronic reading device is configured to receive the written contents from the electronic reading device and translate the written digital contents into the designated language. The translation module is also configured to send the translated written contents to the electronic reading device.

Optionally, the system includes a text-to-speech module configured to convert the translated written contents into an audio signal representing the translated written contents in spoken form. An audio output device may be configured to play the audio signal.

### BRIEF DESCRIPTION OF THE DRAWINGS

The invention will be more fully understood by referring to the following Detailed Description of Specific Embodiments in conjunction with the Drawings, of which:

FIG. 1 is a flowchart of a method for requesting and displaying a translation of an ebook in accordance with an embodiment of the present invention.

FIG. 2 is a flowchart for a method for requesting and displaying a translation of an ebook showing a user's work flow in accordance with an embodiment of the present invention.

### DETAILED DESCRIPTION OF SPECIFIC EMBODIMENTS

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more tangible, non-transitory computer readable medium(s) having computer readable program code stored thereon.

Definitions. As used in this description and the accompanying claims, the following terms shall have the meanings indicated, unless context indicates otherwise.

A “portable electronic reading device” includes all types of portable electronic reading devices capable of displaying digital textual content. This includes but is not limited to eBook Readers such as the Kindle™ from Amazon and Nook™ from Barnes and Noble, smartphones, Personal Digital Assistants (PDAs) and tablet computers such as the iPad™ from Apple. Hereafter, the portable electronic reading devices are also referred to simply as an eReader without intending to restrict it to dedicated eBook readers only. References to eReader may also include electronic reading software programs running on computing devices including those listed above. For example, the program iBooks running on an iPad is within the meaning of the term eReader as used in the present disclosure. Another example of an eBook reader can be found in U.S. Pat. No. 7,748,634, which is hereby incorporated by reference herein in its entirety.

An “eBook” includes all forms of written digital content that can be displayed on a portable electronic reading device. The term “eBook” as used herein is not intended to be restrict to digital format book length publications may also comprise digital magazines, articles, and other forms of written content. The eBook may be in many formats, including but not limited to: .epub, .azw, .pdf, .iba, .htm, .html, .xhtml, .mobi, and .opf,

A “machine translation service” or “machine translation server” in accordance with the present invention refers to any number of computer infrastructure or architecture capable of performing machine translations. Examples of machine translation services or servers are disclosed in U.S. Pat. Nos. 7,512,532 and 7,877,251, which are hereby incorporated by reference herein in their entirety. The machine translation service or server may use application program interfaces (APIs) known in the art to generate the translation. For example, methods for machine translation are disclosed in U.S. Pat. Nos. 5,768,603 and 6,990,439, which are hereby incorporated by reference herein in their entirety. Another example of a machine translation program is Google Translate, available from Google Inc., of Mountain View, Calif. Suitable translations programs and/or APIs are known to persons skill in the art.

A “text-to-speech” functionality in accordance with the present invention refers to any number of systems capable of performing the text to speech conversion. The portable electronic devices referred to with the present invention may use any number of text-to-speech systems known in the art. For example, systems and methods for text to speech conversion are disclosed in U.S. Pat. Nos. 7,454,348 and 7,369,995, which are hereby incorporated by reference herein in their entirety.

Illustrative embodiments of the present invention are directed to methods of providing on-demand translation of electronic documents and other forms of written digital content, including books, magazines, and portable document format files (such as files in the PDF format) to a portable electronic reading device.

Furthermore, illustrative embodiments of the present invention are also direct to providing text-to-speech audio output of the translated electronic documents.

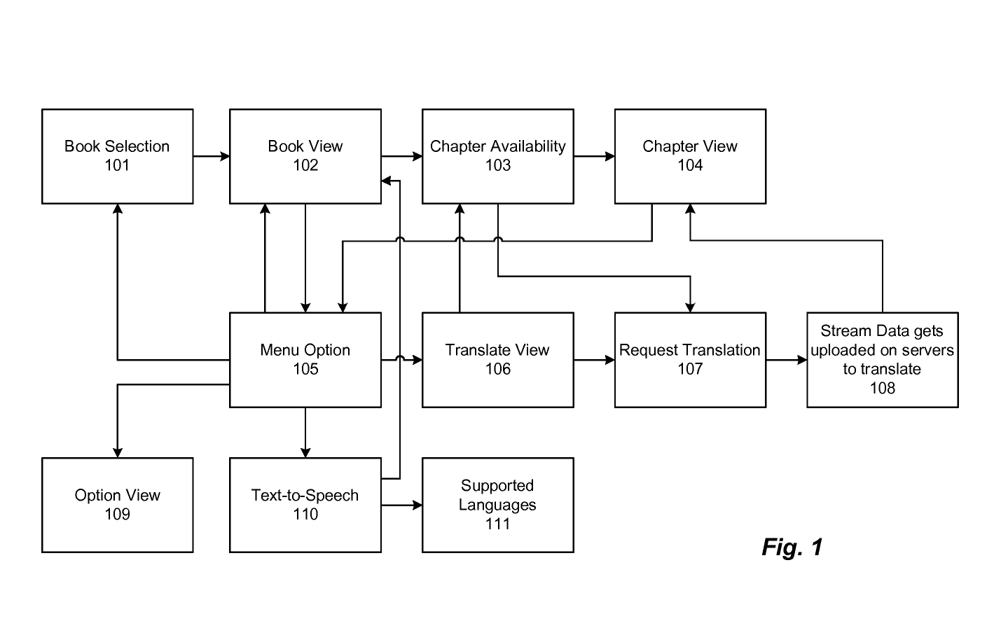

FIG. 1 shows a method for providing a translation of an ebook, along with an option of providing an audio output via a text to speech functionality.

On an eReader, a user begins with a menu 105. In the menu 105 shown in FIG. 1, there are provided five difference menu options, as summarized in Table 1.

TABLE 1

| | |
|---|---|
| Select books | This option allows the user on click to return to a library of books, from which |
| | the user can select to read. Selecting this option leads the user to the “Book |
| | Selection” user interface 101. |
| Read whole book | This option allows the user to return to the entire read version of the entire |
| | book. Selecting this option leads the user to the “Book View” user interface |
| | 102. |
| Text to Speech | This option directs the eReader to read to the user the text on the screen, |
| | provided that a text-to-speech engine for the particular language of the text on |
| | the screen is available on the eReader. Selecting this option leads the user to the |
| | “Text to Speech” user interface 110 |
| Options | This option allows the user to customize the way the user wishes to read the |
| | book. For example, the user may change displayed text size, which may be |
| | helpful as it allows users using a large smartphone as an eReader to change text |
| | to a more readable size than the small default text size of the smartphone and |
| | vice versa for users using smaller smartphones. An eReader with a smaller |
| | screen may benefit from a smaller font size due to the limited screen space |
| | available. Selecting this option leads the user to the “Option View” user |
| | interface 109 |
| Translate | This option transfers the user to a “Translate View” user interface 106. It is |
| | from this user interface that the user directs the eReader to request a translation |
| | of, for example, a specific chapter of an eBook. |

An example of how the user is able to read a translation of an eBook stored on the user's eReader begins at the “Book Selection” user interface 101.

The Book Selection user interface 101 displays a list of eBooks available from the eReader's internal storage, in other words, its library. The user selects an eBook and is taken to the “Book View” user interface 102.

The “Book View” user interface 102 displays the book as a whole, page by page, incrementally. This view includes the introduction to the book prologue, table of contents and chapters. This view is represented page-by-page, which stops flipping if there are no more available pages at the end of the book.

From this “Book View” 102, the user can call up or move to a “Chapter Available” user interface 103. Available chapters are ascertained automatically by referencing the library, which checks inside the eBook to ascertain contents marked as chapters, which allows the user to move to that chapter of the eBook.

Once the user has selected the specific chapter of the eBook to move to, the eReader opens the “Chapter View” user interface 104. The Chapter View 104 is the view in which the chapter contents are seen. This is derived from a menu class. In other embodiments of the present application, other methods of implementing subdivisions of written digital content can be used in place of the traditional book chapter, including but not limited to, subchapters, sections, parts, or acts.

From this Chapter View 104, if the user is interested in receiving a translation of the chapter for display in a language other than the original language of the eBook, the user can move to the Menu 105 from where she can select “Translate” from the list of options, discussed above, with respect to Table 1. Selecting the Translate option takes the user to the “Translate View” user interface 106. By directing the user to select a specific chapter for translation, the present invention can provide automated translation of the ebook to any language of the user's choosing, without requiring the user to engage in a cumbersome procedure of manually selecting or highlighting specific text that the user sees on the display and then requesting a translation of the highlighted text.

The Translate View 106 is the view which shows the user which language the user would like to translate the chapter to. It consists of two views. A first view contains combo boxes, by which the user may choose the book language and the language to translate to. The second view shows the chapter of the book the user wants to translate. In some embodiments of the present invention, these views may be bypassed, based on selections made previously by the user, when the user requested a book translation and/or other digital markers or cookies stored in the eBook or the eReader.

Once the user has entered all the language information, or once the language information has been gathered by eReader in other ways, the eReader sends a request over the internet or via another data communications channel to a server, which performs the machine translation of the selected eBook chapter. In some embodiments of the present invention, Request Translation 107 is a process in which the information goes to the translation servers and checks if the machine translation service is available.

Once the eReader has received an approval from the machine translation server to send the text for translation, all text included in the requested chapter is sent to the machine translation server for processing 108. In some embodiments of the present invention, the text may be sent there on a page-by-page basis.

The translated text from the machine translation server returns and is displayed in Chapter View 104. In order to facilitate a better, more seamless, reading experience, cached translations for a few previous pages and a few pages ahead of the user's current page location are automatically stored on the device or on an active memory which facilitate quick access on the e-reader. This caching allows the user to quickly transition from page to page with minimal lag.

By providing the translated text based on a user's demand in real time, the present invention may enable better translation, as the available machine translators improve and as additional languages become available. This may be preferable compared to a system where the translation displayed is a translation made in the past and stored on a system, which may have become outdated between the time of the translation and a user's request for a translation.

In some embodiments of the present invention, the user may use a Text-to-Speech functionality which is built in the eReader operating system, such as text-to-speech functionally included in the Android Operating System since version 1.5. To access this functionality, the user returns to Menu 105, and from there selects the “Text to Speech” option discussed above, with reference to Table 1.

Selecting this option takes the user to the “Text to Speech” user interface 110. From here, the e-Reader identifies the language of the text previously displayed in the Chapter View 104, which could be translated or original text, and the e-Reader compares it to a list of supported languages. The Supported Languages checking process 111 is a process in which the eReader checks to determine if the language of the text is supported for automatic text-to-speech conversion.

If the language of the text is supported for the text-to-speech functionality, the eReader begins reading the translated text aloud, using its audio interface or equipment. However, if the eReader does not support the language, it does not read the text aloud.

Depending on user preferences and/or locale, the text-to-speech functionality may further include reading the translated text aloud with a specific accent. This availability of accent choices may also be used to read text which may not be available for full text-to-speech conversion based on the language choices. For example, if a user requested a text-to-speech conversion of a Filipino translation from an original English source, and a full Filipino text-to-speech conversion is not available, the eReader may provide the text-to-speech conversion in English with a Filipino accent. In another embodiment, when a text-to-speech conversion for a specific text language is not available, but a related geographic accent is available, the eReader may first request a translation into the language which includes the related geographic accent, and then perform the text-to-speech conversion of this translated text and then read aloud this translated text.

The combination of on-demand, real-time translation and natural accented speech synthesis may provide an advantage of offering users a cost-effective alternative to traditional audio books, which may or may not even be available in the user's desired language.

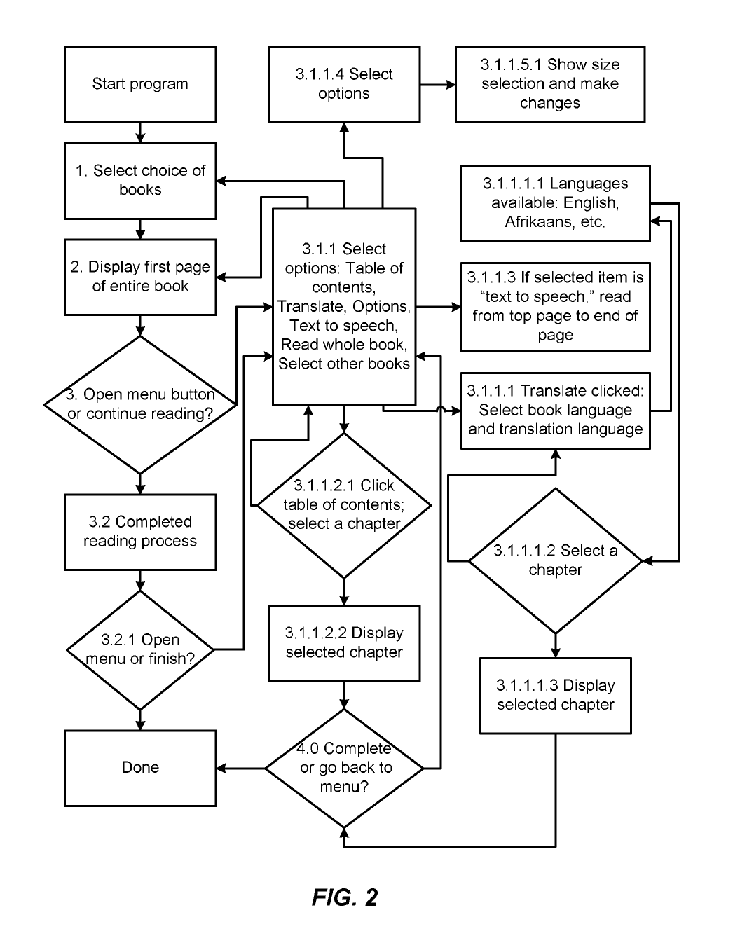

FIG. 2 shows a flowchart of operations for providing a translation and/or providing a text-to-speech conversion of an eBook, in accordance with an embodiment of the present invention.

In operation 1, the user selects an eBook of her choice.

In operation 2, the eReader displays the first page of the book, as selected. In this view, the book is loaded as an entire book, allowing the user the read the entire book page by page, rather than loading only a single selected chapter.

In operation 3, the user decides whether to open an options menu or menu button to select additional options or not to open the menu but rather simply continue reading the eBook.

If the user decides to open the options menu in operation 3, the user is presented with a list of options in operation 3.1.1. There are six options presented in the menu as shown in operation 3.1.1 of FIG. 2, as summarized in Table 2.

TABLE 2

Translate (operation 3.1.1.1)
Translate (operation 3.1.1.1)
Table of Contents (operation 3.1.1.2)
Select Text to Speech (operation 3.1.1.3)
Select other Books (operation 3.1.1.4)
Options (operation 3.1.1.5)
Select Read Whole Book (operation 3.1.1.6)

If the user selects Translate in the menu, the user is first presented with an interface enabling the user to select the language of the book they wish to translate and the language that they wish to translate the book to in operation 3.1.1.1.1. A list of languages, such as English, Afrikaans, etc. Albanian, Arabic, Belarusian, Bulgarian, Catalan, Chinese, Croatian, Czech, Danish, Dutch, Estonian, Filipino, Finnish, French, Galician, German, Greek, Hebrew, Hindi, Hungarian, Icelandic, Indonesian, Irish, Italian, Japanese, Korean, Latvian, Lithuanian, Macedonian, Malay, Maltee, Norwegian, Persian, Polish, Portuguese, Romanian, Russian, Serbian, Slovak, Slovenian, Spanish, Swahili, Swedish, That, Turkish, Ukranian, Vietnamese, Welsh and Yiddish, is shown in 3.1.1.1.1. However, this list is not intended to be exhaustive; the list may include fewer or more languages. Another language may be selected for translation, based on the capabilities of the machine translation service or servers used or available. The user is then prompted to select a chapter of the book for translation in operation 3.1.1.1.2.

Once the language and chapter selections have been made, the eReader requests a translation from a server, which performs the machine translation of the chapter. When the translated text is received from the translation server, the eReader displays the chapter in operation 3.1.1.1.3 to the user. As the user reads the translated eBook (operation 4), the user has the option of continuing his reading, returning to the menu to perform additional tasks, or stopping the eReader.

In operation 3.1.1, the user may select the Table of Contents option (operation 3.1.1.2), which presents the user with an interface listing the chapters of the eBook that was selected in operation 1 and displayed in operation 2. The user may select a chapter (operation 3.1.1.2.1) in this interface and, in response, the eReader displays the chapter for the user to read (operation 3.1.1.2.2). As the user reads the eBook, translated or original (operation 4), she has the option of continuing her reading, returning to the menu to perform additional tasks, or stopping.

In operation 3.1.1., the user may select the Text-to-Speech Option, and the eReader then reads aloud the eBook, translated or original, using the available audio equipment installed on the eReader.

In operation 3.1.1, selecting the Other Books option (3.1.1.4) returns the user to the interface in operation 1.

In operation 3.1.1, the user may choose the “Options” option (3.1.1.5), which provides the user with an interface for changing the reading environment presented by the eReader. For example, the user may change the size of the font or other reading variables (3.1.1.5.1)

In operation 3.1.1., selecting the Read Whole Book option (3.1.1.6) returns the user to the interface in operation 2.

If in operation 2, if the user had not at any time during her reading of the book elected to go to the options menu, the user may simply continue on with the reading process as desired (3.2). The user has the option at any time to open the menu or to end the reading process (3.2.1.2), whether by closing the program, turning off the eReader or any other appropriate method (3.2.1).

All documents cited herein are, in their entirety, incorporated by reference. The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise.

The description of the present invention has been presented for purposes of illustration and description, but is not intended to be exhaustive or limited to embodiments of the invention in the form disclosed. Many modifications and variations will be apparent to those of ordinary skill in the art without departing from the scope and spirit of embodiments of the invention.

Although specific embodiments have been illustrated and described herein, those of ordinary skill in the art appreciate that any arrangement which is calculated to achieve the same purpose may be substituted for the specific embodiments shown and that embodiments of the invention have other applications in other environments. This application is intended to cover any adaptations or variations of the present invention. The following claims are in no way intended to limit the scope of embodiments of the invention to the specific embodiments described herein.

While the invention is described through the above-described exemplary embodiments, modifications to, and variations of, the illustrated embodiments may be made without departing from the inventive concepts disclosed herein. Furthermore, disclosed aspects, or portions of these aspects, may be combined in ways not listed above and/or not explicitly claimed. Accordingly, the invention should not be viewed as being limited to the disclosed embodiments.

Although aspects of embodiments may have been described with reference to flowcharts and/or block diagrams, functions, operations, decisions, etc. of all or a portion of each block, or a combination of blocks, may be combined, separated into separate operations or performed in other orders. All or a portion of each block, or a combination of blocks, may be implemented as computer program instructions (such as software), hardware (such as combinatorial logic, Application Specific Integrated Circuits (ASICs), Field-Programmable Gate Arrays (FPGAs) or other hardware), firmware or combinations thereof. Embodiments may be implemented by a processor executing, or controlled by, instructions stored in a memory. The memory may be random access memory (RAM), read-only memory (ROM), flash memory or any other memory, or combination thereof, suitable for storing control software or other instructions and data. Instructions defining the functions of the present invention may be delivered to a processor in many forms, including, but not limited to, information permanently stored on tangible non-writable storage media (e.g., read-only memory devices within a computer, such as ROM, or devices readable by a computer I/O attachment, such as CD-ROM or DVD disks), information alterably stored on tangible writable storage media (e.g., floppy disks, removable flash memory and hard drives) or information conveyed to a computer through a communication medium, including wired or wireless computer networks. Moreover, while embodiments may be described in connection with various illustrative data structures, the system may be embodied using a variety of data structures.

What is claimed is:

1. A method for providing translated written contents for display on an electronic reading device, the method comprising:
receiving from said electronic reading device a translation request to translate said written contents from a first language to a second language;
receiving from said electronic reading device said written contents in said first language for translation;
translating said written contents into said second language; and
sending translated written contents in said second language to said electronic reading device for display.

2. A method according to claim 1, wherein said written contents comprises at least one of an eBook and a chapter thereof.

3. A method according to claim 1, further comprising converting said translated written contents from a digital written format to an audio signal representing the translated written contents in spoken form.

4. A method according to claim 3, further comprising playing said audio signal.

5. A method according to claim 3, wherein said written contents comprises at least one of an eBook and a chapter thereof.

6. A system for translating and displaying written contents, the system comprising:
an electronic reading device configured to display said written contents;
a user interface on said electronic reading device configured to receive an input indicating a language of said written contents and a designated language, into which to translate said written contents;
a translation module in communication with said electronic reading device configured to: receive said written contents from said electronic reading device, translate said written digital contents into said designated language, and send said translated written contents to said electronic reading device.

7. A system according to claim 6, further comprising a text-to-speech module configured to convert said translated written contents into an audio signal representing said translated written contents in spoken form.

8. A system according to claim 7, further comprising an audio output device configured to play said audio signal.
